(19) United States
(12) Patent Application Publication
(10) Pub. No.: US 2010/0306285 A1
(43) Pub. Date: Dec. 2, 2010

(54) Specifying a Parser Using a Properties File

(75) Inventors: Dhaval M. Shah, Fremont, CA (US); William M. Alexander, Redwood City, CA (US); Hector Aguilar-Macias, San Jose, CA (US); Rubin Jin, San Jose, CA (US)

Correspondence Address: FENWICK & WEST LLP, SILICON VALLEY CENTER, 801 CALIFORNIA STREET, MOUNTAIN VIEW, CA, 94041, US

(73) Assignee: ARCSIGHT, INC., Cupertino, CA (US)

(21) Appl. No.: 12/789,318

(22) Filed: May 27, 2010

Related U.S. Application Data
(60) Provisional application No. 61/182,058, filed on May 28, 2009.
(60) Provisional application No. 61/348,623, filed on May 26, 2010.

(51) Int. Cl. G06F 17/30

(52) U.S. Cl. 707/803; 707/E17.005

(57) ABSTRACT

A system for generating a parser and using the parser to parse a target file includes a target file description, an output format description, a Parser generator, a Parser, a target file, and a result object. The target file description and the output format description are included in one or more “properties files”, which are text files that include one or more name/value pairs (“properties”). The target file description and the output format description are input into the Parser generator, which outputs the Parser. The target file is input into the Parser, which outputs the result object. The target file description specifies one or more parsers and/or tokenizers that can be used to parse the target file. The parsers and/or tokenizers specified by the target file description are part of the generated Parser. These parsers and/or tokenizers make the Parser more flexible, which enables the Parser to parse semi-structured data.

### CROSS-REFERENCE TO RELATED APPLICATIONS

This application claims priority from U.S. provisional application No. 61/182,058, filed May 28, 2009, entitled “Specifying Parsers/Tokenizers Using a Properties File” and U.S. provisional application No. 61/348,623, filed May 26, 2010, entitled “Specifying a Parser Using a Properties File”, both of which are incorporated by reference herein in their entirety.

### BACKGROUND

1. Field of Art

This application generally relates to generating a parser. More particularly, it relates to generating a parser based on a properties file, which includes one or more name/value pairs.

2. Description of the Related Art

A “parser generator” is a tool that creates a parsing program (“parser”). The created parser is able to parse a particular type of textual input. The textual input adheres to a specific syntax (“grammar”). The parser is created based on this grammar—specifically, based on a description or definition of the grammar and its rules. The grammar description or definition is written in a language called a “grammar description language” or “grammar definition language.” One common type of parser generator takes as input a grammar description of a programming language and generates source code of a parser that can be used to parse text that adheres to that programming language.

A parser generator can be used to generate different parsers. Inputting a description of a first grammar into the parser generator will cause the parser generator to generate a first parser, which can be used to parse a first type of textual input (i.e., textual input that adheres to the first grammar). Inputting a description of a second grammar into the parser generator will cause the parser generator to generate a second parser, which can be used to parse a second type of textual input (i.e., textual input that adheres to the second grammar).

So, if a person needs a parser, he can use a parser generator to generate the parser. The person need only provide a grammar description. Usually, the grammar description must be in Backus-Naur Form (BNF) or some other formal language in order to be processed by the parser generator. Unfortunately, it is difficult for a person who is not a programmer to provide this type of grammar description.

### SUMMARY

Inputting a description of a grammar into a parser generator causes the parser generator to generate a parser, which can be used to parse textual input that adheres to that grammar. In one embodiment, a “properties file” is used as the grammar description. A properties file is a text file that includes one or more name/value pairs, where each pair is referred to as a “property.” Inputting the properties file into a parser generator causes the parser generator to generate a parser that can parse textual input that adheres to a grammar (specifically, the grammar described by the properties file). Many different properties files can be created. Each properties file can be used to generate a different parser, and each parser can parse textual input that adheres to a different grammar (specifically, the grammar described by the properties file).

In one embodiment, a system for generating a parser based on a properties file and using the parser to parse a target file includes a target file description, an output format description, a Parser generator, a Parser, a target file, and a result object. The target file description and the output format description are input into the Parser generator. The Parser generator outputs the Parser. The target file is input into the Parser. The Parser outputs the result object. The word “Parser” is capitalized in order to distinguish the Parser from other “parsers” (not capitalized).

In one embodiment, the target file description describes the grammar of the target file in a roundabout way. Rather than describe the target file's grammar directly, the target file description instead specifies one or more parsers (not capitalized) and/or one or more tokenizers that can be used to parse the target file. The parsers and/or tokenizers specified by the target file description are part of the generated Parser. These parsers and/or tokenizers make the Parser more flexible, which enables the Parser to parse semi-structured data.

In one embodiment, the target file description codifies parsers and/or tokenizers to parse and tokenize data from a device configuration file (target file), and the output format description describes how to map the parsed data to an extensible data structure (result object). The target file description and the output format description are contained in a properties file.

In one embodiment, the generated Parser can act as a device driver and interact with a device. In this embodiment, the target file description codifies parsers and/or tokenizers to parse and tokenize data from a response output by the device (target file), and the output format description describes how to use the parsed data to create a command to send to the device (result object). The target file description and the output format description are contained in a properties file.

### BRIEF DESCRIPTION OF DRAWINGS

FIG. 1 is a block diagram of a system for generating a Parser based on a properties file and using the Parser to parse a target file, according to one embodiment of the invention.

FIG. 2 is a block diagram of a system with a Parser generator for generating a Parser based on a properties file and using the Parser to parse a target file, according to one embodiment of the invention.

FIG. 3 is a tree representing a property map, according to one embodiment of the invention.

FIG. 4 is a tree representing a property map, according to one embodiment of the invention.

FIG. 5 is a flowchart of a method for generating a Parser based on a properties file and using the Parser to parse a target file, according to one embodiment of the invention.

### DETAILED DESCRIPTION

The features and advantages described in the specification are not all inclusive and, in particular, many additional features and advantages will be apparent to one of ordinary skill in the art in view of the drawings, specification, and claims. The language used in the specification has been principally selected for readability and instructional purposes and may not have been selected to delineate or circumscribe the disclosed subject matter.

The figures and the following description relate to embodiments of the invention by way of illustration only. Alternative embodiments of the structures and methods disclosed here may be employed without departing from the principles of what is claimed.

Reference will now be made in detail to several embodiments, examples of which are illustrated in the accompanying figures. Wherever practicable, similar or like reference numbers may be used in the figures and may indicate similar or like functionality. The figures depict embodiments of the disclosed systems (or methods) for purposes of illustration only. One skilled in the art will readily recognize from the following description that alternative embodiments of the structures and methods illustrated herein may be employed without departing from the principles described herein.

A “properties file” is a text file that includes one or more name/value pairs, where each pair is referred to as a “property.” In one embodiment, each property includes two elements (a property name and a property value) and adheres to the format “name=value”, where “=” is the equals sign. For example, the property “class=TableParser” includes the name “class” and the value “TableParser”. Everything to the left of the “=” is the name of the property, and everything to the right of the “=” is the value of the property. Each property starts on a separate line of the file. In one embodiment, a properties file is a Java Properties file, which is part of the java.util package (e.g., see the Java Platform Standard Edition 6 from Oracle Corp. of Redwood Shores, Calif.).

A properties file is used as the basis for generation of a parser. As explained above, inputting a description of a grammar into a parser generator causes the parser generator to generate a parser, which can be used to parse textual input that adheres to that grammar. Here, a properties file is used as the grammar description. Inputting the properties file into a parser generator causes the parser generator to generate a parser that can parse textual input that adheres to a grammar (specifically, the grammar described by the properties file). Many different properties files can be created. Each properties file can be used to generate a different parser, and each parser can parse textual input that adheres to a different grammar (specifically, the grammar described by the properties file).

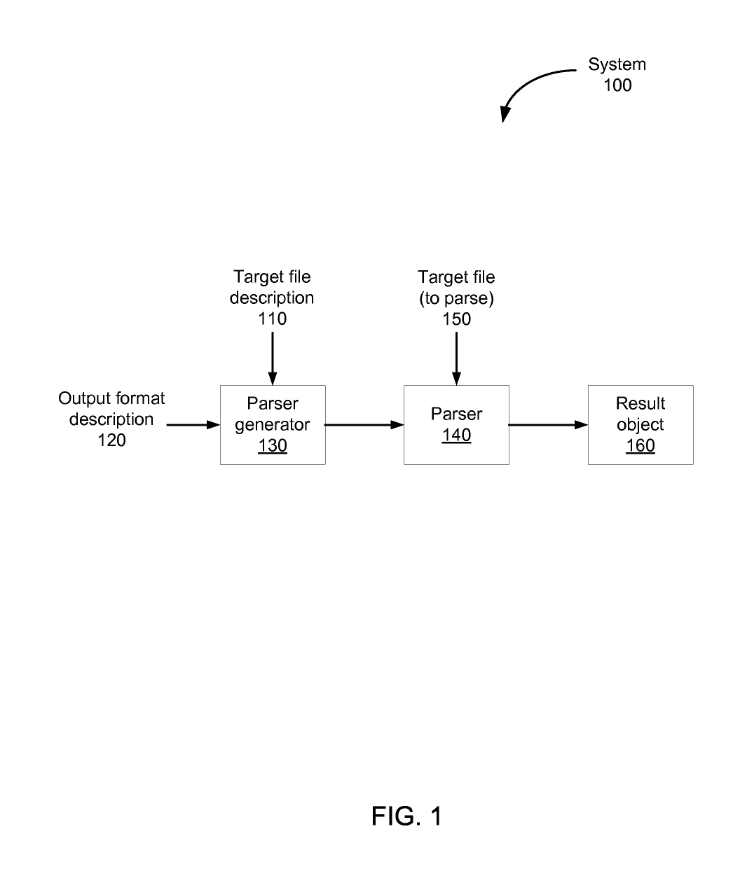

FIG. 1 is a block diagram of a system for generating a Parser based on a properties file and using the Parser to parse a target file, according to one embodiment of the invention. The illustrated system 100 includes a target file description 110, an output format description 120, a Parser generator 130, a Parser 140, a target file 150, and a result object 160. The word “Parser” is capitalized in order to distinguish the Parser 140 from other parsers (not capitalized), which are described below.

The target file 150 is a text file that is to be parsed. The text in the target file 150 adheres to a grammar. The target file description 110 describes the grammar to which the text in the target file 150 adheres. In one embodiment, the target file description 110 is contained in a properties file.

The output format description 120 describes how to format the result object 160, which is output from the Parser 140. In one embodiment, the output format description 120 is contained in a properties file (either the same properties file as the target file description 110 or a different properties file).

The result object 160 contains the results of parsing the target file 150. The result object 160 is formatted according to the output format description 120.

Regarding how system 100 works, the target file description 110 and the output format description 120 are input into the Parser generator 130. The Parser generator 130 outputs the Parser 140. The target file 150 is input into the Parser 140. The Parser outputs the result object 160.

In one embodiment, the target file description 110 describes the grammar of the target file 150 in a roundabout way. Rather than describe the target file's grammar directly, the target file description 110 instead specifies one or more parsers (not capitalized) and/or one or more tokenizers that can be used to parse the target file 150. The parsers and/or tokenizers specified by the target file description 110 are part of the generated Parser 140. These parsers and/or tokenizers make the Parser 140 more flexible, which enables the Parser to parse semi-structured data.

If multiple parsers are specified, they can form either a) an “assembly” or b) a “chain” or “pipeline.” The parsers in an assembly can be independent or interdependent. In an interdependent set of parsers, the parsed output data of one parser forms the input data to a downstream parser. Similarly, parsers can be chained independently or interdependently. A properties file supports the use of references (links). As a result, common properties and parsers can be reused. Also, complex data can be parsed recursively.

In one embodiment, the target file description 110 can specify any of six different parsers: scalar parser, table parser, compound parser, choice parser, multipass parser, and XML (Extended Markup Language) parser. Each parser is associated with a class of a similar name. For example, a table parser is associated with the “TableParser” class (part of the com.arcsight.nsp package).

A scalar parser sets a value of an attribute of a result object 160 based on a value of a parsed token. For example, the name/value pair (property) parser. item. attr=<expression> in the target file description 110 specifies that <expression> should be evaluated and that the value of <expression> should be assigned to the attribute “attr” of the result object 160. A scalar parser can call a list of sub-parsers on parsed data.

A table parser maps the contents of a table to a list of objects. Each conceptual row in the table is parsed by the table parser's row parser. The row parser can be any kind of parser.

A compound parser applies a series of sub-parsers to a string. Each sub-parser parses only that part of the string that was not parsed by the previous sub-parsers.

A choice parser includes a set of sub-parsers that can be executed in a specific order. The choice parser tries to parse a string using each sub-parser, in order, until a sub-parser is found that can parse the string successfully. This is referred to as an “assembly” of parsers and enables a choice parser to perform a dedicated function. The choice parser returns the results of the first successful parse.

A multipass parser parses the same string multiple times. Each parse is performed using a different sub-parser.

An XML parser parses an XML string. The XML parser can be chained with other parsers. In one embodiment, the XML parser is implemented using the Digester package from the Commons project of the Apache Software Foundation.

In one embodiment, the target file description 110 can specify any of four different tokenizers: null tokenizer, split tokenizer, regex (regular expression) tokenizer, and hierarchy tokenizer. A null tokenizer does not split a string at all. Instead, the null tokenizer applies a “begin” object and an “end” object to a string and then returns the remaining string as a single token.

A split tokenizer splits a string into token values that are found between matches to a specified regular expression or a specified string. For example, if the regular expression is “ ”, then all space-separated strings will be found.

A regex tokenizer assigns a token to a match of a specific regular expression. The regex tokenizer returns the entire matched string as token 0 and each of the groups specified in the regex as tokens 1 through n.

A hierarchy tokenizer tokenizes a string containing hierarchically-nested data. Tokens are identified based on nesting levels of delimiters (e.g., “{” or “]”). The beginning and the ending of the string should have the same nesting level.

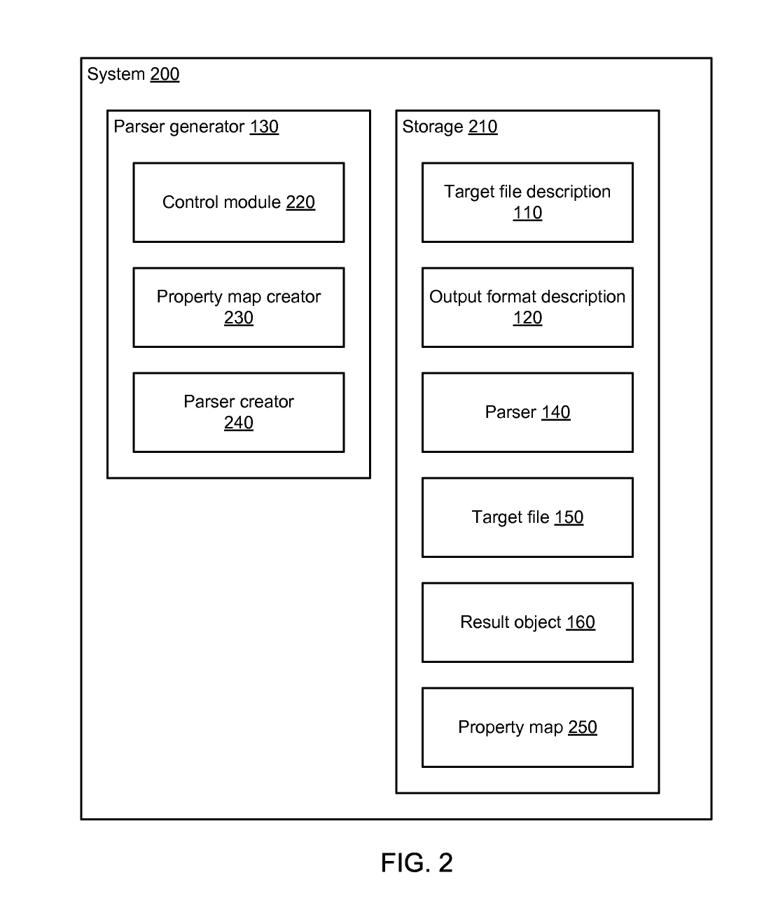

FIG. 2 is a block diagram of a system with a Parser generator 130 for generating a Parser based on a properties file and using the Parser to parse a target file, according to one embodiment of the invention. The system 200 is able to generate a Parser based on a properties file and use the Parser to parse a target file. The illustrated system 200 includes a Parser generator 130 and storage 210.

In one embodiment, the Parser generator 130 (and its component modules) is one or more computer program modules stored on one or more computer readable storage mediums and executing on one or more processors. The storage 210 (and its contents) is stored on one or more computer readable storage mediums. Additionally, the Parser generator 130 (and its component modules) and the storage 515 are communicatively coupled to one another to at least the extent that data can be passed between them.

The storage 210 stores a target file description 110, an output format description 120, a Parser 140, a target file 150, a result object 160, and a property map 250. The target file description 110, output format description 120, Parser 140, target file 150, and result object 160 were described above with reference to FIG. 1. Initially, when the system 200 has not yet been used, the Parser 140, the result object 160, and the property map 250 have not yet been created.

A property map (e.g., property map 250) is a data structure that stores information from a properties file (e.g., the target file description 110 and/or the output format description 120) and enables convenient access to that information. A property map can be thought of as a tree of properties. If a property map is thought of as a tree, then each branch in the tree can be identified by a prefix. When all of the properties whose names begin with a particular prefix have been processed, the result is a branch of a property map tree for that prefix. After obtaining the property map for that branch, the prefix itself does not need to be saved in the in-memory representation (e.g., object representation). Hence, in essence, a prefix helps identify a particular branch in a property map tree.

Properties can be modeled as objects. So, a property map can be a tree of objects. A period in a property name is used as a delimiter between an object name and that object's attribute. Subscripts are indicated in array style (e.g., “[i]”).

The keyword “class” has a special meaning A class can be a parser or a tokenizer. In one embodiment, there are pre-defined parsers and/or pre-defined tokenizers, each with a specific function. (See the parsers and tokenizers described above.) The words “parser” and “tokenizer” will be used inter-changeably from now on, in the context of “class”.

For example, consider the following properties:

class=CompoundParser
parsers.count=2
parsers[0].tokenizer.start.ignore_lines=1
parsers[0].max-tokens=4
parsers[0].item.device.device_name=$1
parsers[0].item.device.device_model=$3
parsers[1].tokenizer.class=NullTokenizer
parsers[1].tokenizer.start.string=[
parsers[1].tokenizer.end.string=]
parsers[1].max-tokens=1
parsers[1].item.device.device_os_version=$0

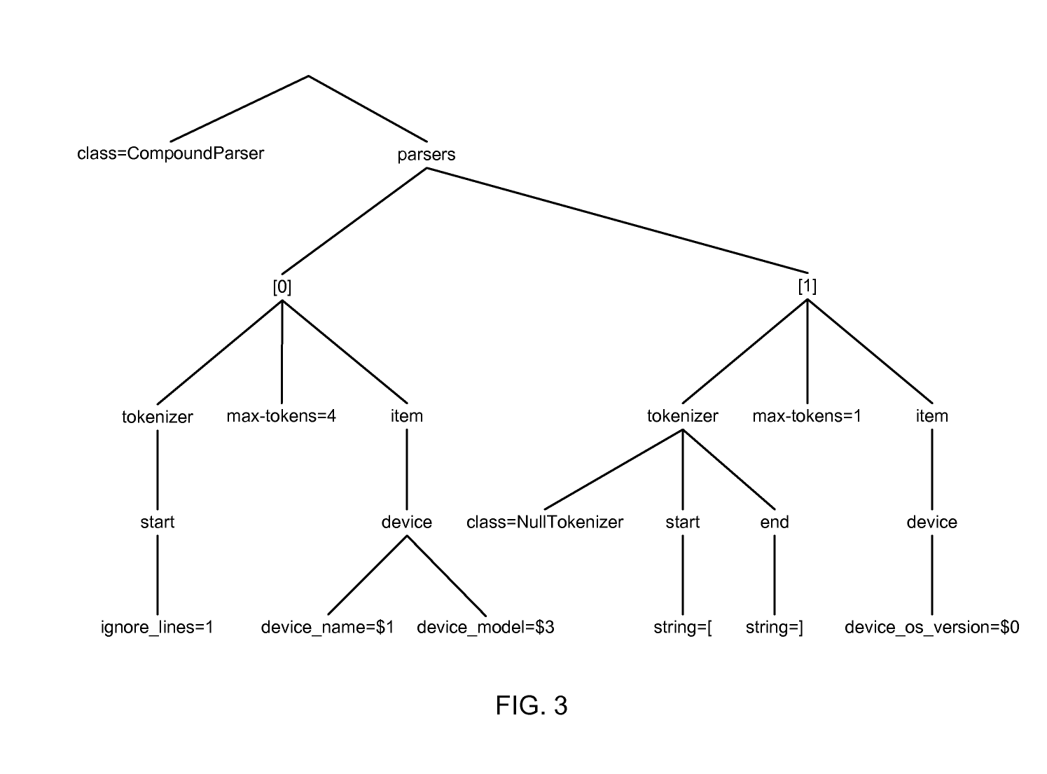

FIG. 3 is a tree representing a property map, according to one embodiment of the invention. The tree in FIG. 3 represents a property map made from the above properties. Note that the property names (e.g., “parsers[0].tokenizer.start.ignore_lines” and “parsers[1].max-tokens”) are split up into multiple parts based on a delimiter (here, a period). Note also that the property “parsers.count=2” is not shown in FIG. 3. A “count=n” property indicates how many indices there are in an array (e.g., the “parsers” array). When the properties are represented as a property map, the “count” number is not necessary.

In FIG. 3, a leaf of the tree corresponds to a property (e.g., a line in a properties file) that has a simple value (e.g., “4”). Properties that do not have simple values are branches in the tree. Branch names are separated by delimiters (here, periods) in the property name. In the case of array indices (a number surrounded by brackets, e.g., “[0]”), the beginning of an array index indicates the beginning of a new branch.

As mentioned above, a properties file supports the use of references (links) For example, a property “key” (e.g., property name) can have a value that, in turn, is a key to another value. So, a property map can be a tree of interlinked objects (e.g., objects that are linked based on property names and property values). In one embodiment, a link is indicated in a property by a property name that ends with “.link”. The property value of that property points (links) to a “key” (property name) in the properties file. Using a link provides two advantages: 1) If a portion of the properties file would normally be repeated in different places, that portion can be put in the file only once and then linked to as needed. This way, if the portion needs to be changed later, the change need be made only once in the file. 2) The length of a property name is reduced, thus making it easier to read.

For example, consider the following properties:

class=TableParser
row_parser.class=ChoiceParser
row_parser.parsers.count=2
row_parser.parsers[0].link=Version
row_parser.parsers[1].link=Version
Version.tokenizer.class=RegexTokenizer
Version.tokenizer.regex=version ([\hat{ };]+);
Version.item.type=“Version”
Version.item.label=$1
Version.item.parsedText=$0

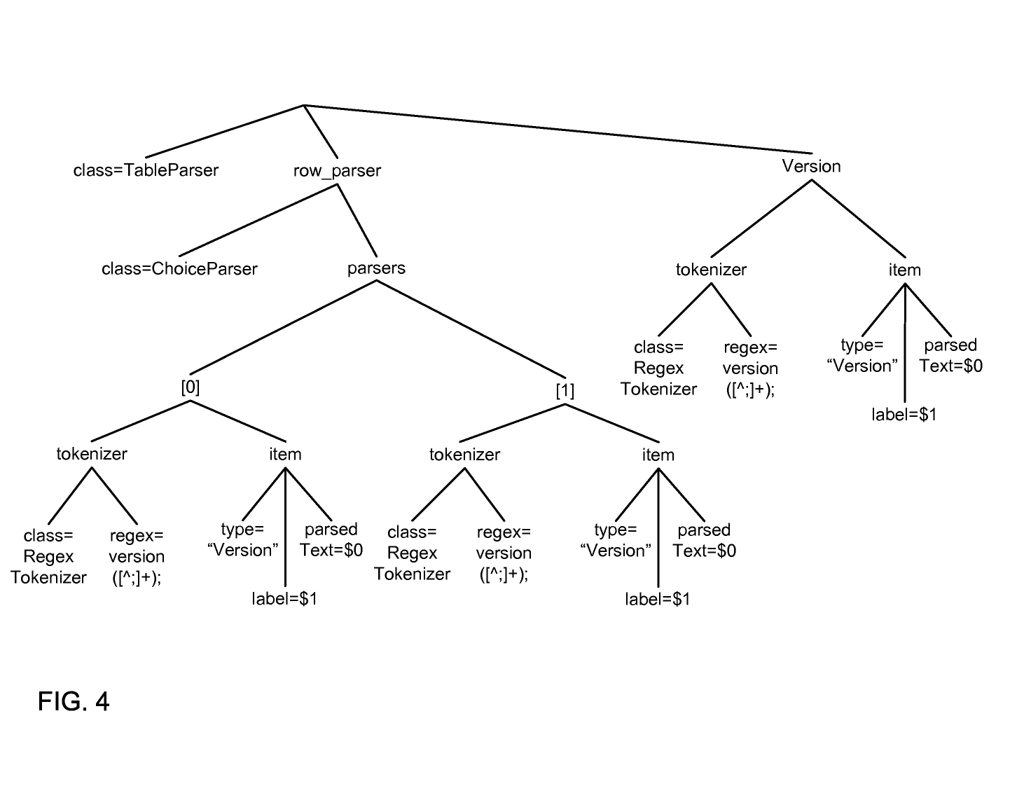

Some of the property “keys” (e.g., property names) are “row_parser.parsers[0] link” and “Version.tokenizer.class”. Note that “Version” is also a property value. FIG. 4 is a tree representing a property map, according to one embodiment of the invention. The tree in FIG. 4 represents a property map made from the above properties. Note that the Version sub-tree is present a total of three times. Note also that the property “row_parser.parsers.count=2” is not shown in FIG. 4. A “count=n” property indicates how many indices there are in an array (e.g., the “row_parser.parsers” array). When the properties are represented as a property map, the “count” number is not necessary.

The Parser generator 130 includes several modules, such as a control module 220, a property map creator 230, and a Parser creator 240. The control module 220 controls the operation of the Parser generator 130 (i.e., its various modules) so that the Parser generator 130 can generate a Parser based on a properties file and use the Parser to parse a target file.

The property map creator 230 creates a property map 250 based on a properties file.

The Parser creator 240 creates a Parser 130 based on a target file description 110 and an output format description 120. In one embodiment, the Parser 130 and the parsers and/or tokenizers are Java Beans objects (part of the java.beans package; e.g., see the Java Platform Standard Edition 6 from Oracle Corp.). A Java Bean is an instance of a Java class that adheres to certain conventions that make the instance easy to create and manipulate. In one embodiment, the Parser 130 and the parsers and/or tokenizers are created using the BeanFactory class. The BeanFactory class creates a Java Bean of a specified class or sub-class (e.g., a parser or tokenizer) using the abstract factory software design pattern. This is the basic mechanism for creating classes without actually hard-coding their types.

First, the main Parser object is created (Parser 130). Then, that main Parser object creates the parsers, tokenizers, and other objects (e.g., beans) that it needs. This is performed as follows: The portion of a property map 250 for a given bean is passed to a BeanFactory object. The BeanFactory object uses the value of the “class” property from the map (or a default value) to determine the class of the bean. An instance of the specified class is created. The “init” (initialize) method of the determined class is called, and the property map portion is passed as an argument. The init method initializes attributes on the object and creates all sub-objects. Creating a sub-object is performed by calling a BeanFactory method. The code then recurses as needed. At the end, the newly-created object is returned to the calling function.

In one embodiment, a parser object adheres to the class “Parser” and inherits from the class “AbstractParser”. The Parser class is a public interface that parses a string (generally using a tokenizer) and then puts the results in a resultBean. The AbstractParser class is an abstract base class for a parser. The AbstractParser class determines what will be parsed. Typically this will be the passed in value but, if specified, a value calculated from the “expr” (expression) property can be used instead. The AbstractParser class sets up a relationship with a tokenizer (e.g., it enables the tokenizer to parse an input string into pieces and pass the pieces to the parser). The AbstractParser class returns the unparsed portion of its input. This unparsed portion is sometimes used by downstream parsers.

In one embodiment, a tokenizer object adheres to the class “Tokenizer” and inherits from the class “AbstractTokenizer”. The Tokenizer class is a public interface that splits a given string into smaller tokens. The AbstractTokenizer class is an abstract base class for a tokenizer.

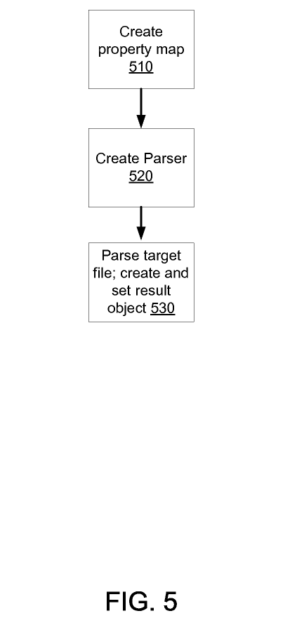

FIG. 5 is a flowchart of a method for generating a Parser based on a properties file and using the Parser to parse a target file, according to one embodiment of the invention. In step 510, a property map is created. For example, the control module 220 uses the property map creator 230 to create a property map 250 based on the target file description 110.

In step 520, a Parser 130 is created. For example, the control module 220 uses the Parser creator 240 to create a Parser 130 (and its sub-objects) based on the target file description 110 and the output format description 120.

In step 530, the target file 150 is parsed, and the result object 160 is created and set. The result object 160 will eventually contain the parsed results from the target file 150. In one embodiment, the control module 220 creates the result object 160 using the assembler software design pattern. An initial result object 160 is created based on the output format description 120. If the output format description 120 specifies default values, then the initial result object 160 is set using those default values.

For example, here are some result properties from an output format description 120 for a driver discovery request (drivers are further discussed below):

discovery.result.cm_registration.cm_device_registry_ftp=3
discovery.result.cm_registration.cm_device_registry_tftp=0
discovery.result.registration.count=1
discovery.result.registration[0].job_task_type_id=6
discovery.result.registration[0].task_reg_action_type=block_ip

These properties provide an initial configuration for the result object as follows:

```
result
  cm_registration
    cm_device_registry_ftp=3
    cm_device_registry_tftp=0
  registration
    [0]
    job_task_type_id=6
    task_reg_action_type=block_ip
```

Although this example does not show it, the classes for the result object 160 and/or its sub-objects can also be specified. Also, note that the result property “discovery.result.registration.count=1” is not shown in the above result object initial configuration. A “count=n” property indicates how many indices there are in an array (e.g., the “registration” array). When the result properties are mapped into memory (e.g., as a result object), the “count” number is not necessary.

In one embodiment, the result object 160 is created by first creating the main result object. If the result.class property name exists, then the value of that class is used as the class of the main result object. If the result.class property name does not exist, then a default class is used. In either case, a BeanFactory object performs the creation. If descendant objects (e.g., sub-objects) are specified in the output format description 120, then they are created (recursively) in a similar fashion.

The target file 150 is then parsed, and the result object 160 is set. For example, the control module 220 uses the Parser 130 to parse the target file 150 and set the results in the result object 160. The control module 220 then returns the result object 160 to the calling function.

Parsing the target file 150 is performed recursively, with parsers passing portions of the to-be-parsed string input to sub-parsers. Most of the parsers at the bottom of the parsing tree (e.g., the property map based on the target file description 110) are scalar parsers, which can set a value on the result object 160.

Devices (e.g., switches and routers) have device-specific configuration files. A device configuration file contains several details that are useful to track for auditing, reporting, and response purposes. The challenge is that the syntax and semantics of a device configuration file are specific to a device version and its vendor. Two devices of the same class with similar functions from different vendors have entirely different configuration files and interpretations of those configuration files. Further, the configuration file format can change from one version to another version for the same type of device from the same vendor. This interferes with any generic ability to pull out any information (in a common class or category regarding the device) from the device and track it for audit, report, and response purposes. As such, any solution that can be applied in a vendor-agnostic, device version-agnostic manner to parse out details for auditing, reporting, and response needs is welcome.

Without a vendor-agnostic solution, workers in the industry have had to use a vendor-specific solution resulting in a vendor tie-in. Previous solutions to this problem included creating Perl script-based regular expressions (“regexes”), which were tedious to create and implement. Further, the implementer needed to have complete knowledge of Perl and regexes. Also, regexes that had been developed could not be chained and were not device-, version-, or vendor-agnostic.

In one embodiment, the system 100 is used to generate a Parser that can parse a device configuration file. In this embodiment, the target file description 110 codifies parsers and/or tokenizers to parse and tokenize data from the configuration file (target file 150), and the output format description 120 describes how to map the parsed data to an extensible data structure (result object 160). The target file description 110 and the output format description 120 are contained in a properties file. In one embodiment, using a properties file in this way is similar to the “custom attributes” feature in the ArcSight Network Synergy Platform (NSP) (from ArcSight, Inc. of Cupertino, Calif.), and the properties file is similar to a “custom attributes file”.

In the custom attributes feature, information in different formats is parsed and categorized into the same custom-defined classes or fields (referred to as “custom attributes”) (e.g., the result object 160). The information in different formats can be, e.g., configuration files for various device types and device vendors. In other words, free-form attributes can be parsed from a device configuration and arranged into pre-defined named custom attributes. This enables appropriate categorization of free-form device configuration. Categorization of data independent of the device type and device vendor enables reporting on the attributes without worrying about how the underlying data is stored and interpreted by the device itself. This approach works for both OSI Layer 2 applications (e.g., switches) and OSI Layer 7 applications (e.g., Active Directory).

For example, here is a configuration file (target file 150) that contains an interface definition from a Cisco router:

```
interface Dot11Radio0
  no ip address
  no ip route-cache
  shutdown
  speed basic-1.0 basic-2.0 basic-5.5 basic-11.0
  station-role root
  bridge-group 1
  bridge-group 1 subscriber-loop-control
  bridge-group 1 block-unknown-source
  no bridge-group 1 source-learning
  no bridge-group 1 unicast-flooding
  bridge-group 1 spanning-disabled
!
```

This information can be parsed and then stored in an object of the custom-defined “interface” class. A user can define the interface class and its attributes. A value of an attribute can be a simple value or another object. The interface object would correspond to the result object 160.

Appendix A includes an exemplary custom attributes file (target file description 110) for a Juniper configuration file (target file 150). Lines that start with “#” are comments. Appendix A forms part of this disclosure.

As described above, a properties file enables parsed data to be mapped to a custom defined data structure. For example, as part of discovery of a device, obtaining additional IPv6 layer 3 interfaces is desired. This is new information which has not previously been seen but is now of interest because the device supports it. To register interest in this new information, one can create a class called “Layer3Interface_V6” (lines that start with “//” are comments):

```
public class Layer3Interface {
  public String name;
  @Assembled(itemClass = IP.class)
  public AssemblerList<IP> children;
}
public class Layer3Interface_V6 extends Layer3Interface {
  // Has different behavior based on the V6 Interface
  public String name;
  @Assembled(itemClass = IPV6.class)
  public AssemblerList<IPV6> ipV6_children;
}
```

The Layer3Interface_V6 class can then be used in a properties file:

# Get the layer3interface from device
result[0].class=Layer3Interface
result[0].name=layer3Interface
result[0].children.count=1
result[0].children[0].class=IP
result[0].children[0].name=″IPV4″
# Get IPV6 layer3interfaces from device
result[1].class=Layer3Interface_v6
result[1].name=v6_layer3interfaces
result[1].children.count=1
result[1].children[0].class=IPV6
result[1].children[0].name=”ipv6”
...

Interacting with various device types is a major challenge. This is compounded further by the challenge that different device vendors for the same device type present similar data differently. A normal interaction with a device requires a command-response scheme where the next command in sequence is an interpretation of the response to the previous command. The interpretation of the response requires a chain of parsers.

The parsers and drivers using those parsers, particularly for interactive command-response, are generally derived from a scripting language like Perl or Tcl/Tk. One of the major challenges with such a scheme is that one has to be knowledgeable about the scripting language. Further, the driver scripts themselves cannot be shared or understood easily. It is difficult to automatically compare the different script versions even if they pertain to the same device type and vendor.

In one embodiment, the system 100 is used to generate a Parser that can act as a device driver and interact with a device. In this embodiment, the target file description 110 codifies parsers and/or tokenizers to parse and tokenize data from a response output by the device (target file 150), and the output format description 120 describes how to use the parsed data to create a command to send to the device (result object 160). The target file description 110 and the output format description 120 are contained in a properties file. In one embodiment, using a properties file in this way is similar to the “device driver” feature in the ArcSight Network Synergy Platform (NSP) (from ArcSight, Inc. of Cupertino, Calif.), and the properties file is similar to a “driver file”. A driver file is registered with NSP as a driver.

In the device driver feature, a command (e.g., a query or request) is sent to a remote device or application using a specific transport handler (e.g., telnet/SSH). The remote device/application executes the command and outputs a response (target file 150). The parser (Parser 130) can parse the response. Based on the parsed response, a next command (to send to the remote device/application) is determined (response object 160). A properties file is a tree structure of objects that processes a set of commands. The commands can also be thought of as a tree structure of objects. Device-specific configurations are thereby treated in a generic manner, and the devices are commoditized. This approach works for OSI Layer 2 applications (e.g., switches) through OSI Layer 7 applications (e.g., Microsoft Active Directory). In particular, the approach encompasses switches, routers, firewalls, and applications (including web services) that can be mapped to OSI Layer 2 through OSI Layer 7.

Pipelining of multiple parsers enables interactivity with the device. A properties file enables polling (i.e., a command can be issued on a remote device, its output parsed, and, based on the parsed output, further action can be taken including issuing further commands). Example properties file—Driver issues commands depending on the results of previous commands:

discovery.commands.count=2
discovery.commands[0].command.string=show version\n
discovery.commands[0].parser.item.os_version=$0
# store output from “show version” command into os_version variable.
# select a command depending on the operating system of the device.
discovery.commands[1].command.string=_ifThenElse(result.os_version,
“12.2”, “show mac\n”, “show mac-address\n”)

As mentioned above, references (links) enable reuse of common properties and parsers. For example, a discovery command and a mac_cache_refresh command (application business layer logic in NSP) populate an identical data structure (for storage) based on device details. The ability to extract that information can be centralized in one portion of a properties file and then referenced where it needs to be reused:

# Discovery commands and mac_cache_refresh commands need
# information from device storage
discovery.commands[1].link=device_storage
mac_cache_refresh.commands[1].link=device_storage
# Describe how device_storage will interrogate the device and parse
# out device_storage information.
device_storage. [... rest of the details ...]

As mentioned above, references (links) also enable recursive parsing of complex data. For example, the following properties are the skeleton for code to parse a generic tree consisting of Leafs and Branches. Additional lines would be needed to specify the tokenizing rules (and probably to set additional properties on Branch and Leaf):

# Define a link called “Branch”
discovery.commands[0].parser.link=Branch
# Define how the Branch can be parsed
Branch.class=TableParser
Branch.row_parser=ChoiceParser
Branch.row_parser.parsers.count=2
Branch.row_parser.parsers[0].link=Leaf # Parse the leaf
Branch.row_parser.parsers[1].link=Branch
# Parse the sub branch calling itself recursively
# The leaf parser
Leaf.item.name=$0

An example is now presented to illustrate how a driver file (properties file) is used to perform device discovery. The call sequence proceeds as follows:

1) User initiates discovery of a device from the NSP UI (user interface), which results in NSP reading driver information from the drivers table and driver parameters from the driver_defs table.

2) The driver file associated with the driver name is read in, and the parameters registered into the driver_defs table as part of driver installation are passed as parameters. The parameters are added to the properties of a “Context object” created to represent the driver metadata.

3) A Request object corresponding to the type of request is created to the specification given in the Context object. For example, a discovery request results in a request object of the type DiscoveryRequest.

4) The invoke method is called on the Request object. An invoke method runs a series of commands and packages up the results into a response object. If an error is found, an exception will be thrown, which will cause processing of the command to terminate. If no error is found, then the result object is returned to the caller. Commands are processed by the CommandProcessor, as follows:

A) The command string is sent to the Transport object, which handles communication with the device. B) The response is read from the Transport object. When data is received, the appropriate method (PromptCheck.isEnd) is called to determine if the end of the response has been reached. This is normally detected by receiving a prompt for the next command. C) If ErrorCheck objects have been configured on the Command, they are passed the value of the response to see if it is an error message. If it is, then an Exception is thrown to signal the problem. D) The response is passed to the Parser object of the Command, which sets properties on the result object based on the values in the response. In most cases, it does so as follows: i) The Parser's Tokenizer splits the response into a series of tokens. ii) Each token is (optionally) converted from a string to an Object using a TokenParser. iii) Result object fields are set to the values of expressions given in the properties file.

5) The returned values are processed by NSP to indicate the status of the operation. A discovery operation results in the device details populated in the NSP schema in the device table.

Reference in the specification to “one embodiment” or to “an embodiment” means that a particular feature, structure, or characteristic described in connection with the embodiments is included in at least one embodiment of the invention. The appearances of the phrase “in one embodiment” or “a preferred embodiment” in various places in the specification are not necessarily all referring to the same embodiment.

Some portions of the above are presented in terms of methods and symbolic representations of operations on data bits within a computer memory. These descriptions and representations are the means used by those skilled in the art to most effectively convey the substance of their work to others skilled in the art. A method is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of a method. It should be noted that the process steps and instructions of the present invention can be embodied in software, firmware or hardware, and when embodied in software, can be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The methods and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the above description. In addition, the present invention is not described with reference to any particular programming language. It will be appreciated that a variety of programming languages may be used to implement the teachings of the present invention as described herein, and any references above to specific languages are provided for disclosure of enablement and best mode of the present invention.

While the invention has been particularly shown and described with reference to a preferred embodiment and several alternate embodiments, it will be understood by persons skilled in the relevant art that various changes in form and details can be made therein without departing from the spirit and scope of the invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

1. A method for generating a Parser to parse a target file, comprising:
receiving a description of the target file, wherein the target file description describes a grammar of the target file by specifying a set of one or more parsers, and wherein each parser specification includes one or more pairs of a name and a value;
creating a data structure that represents the target file description; and
creating, for each parser in the set of parsers, an object that can parse a string.

2. The method of claim 1, wherein the target file describes a configuration of a device.

3. The method of claim 1, wherein the target file was output by a device in response to a command that was received by the device.

4. The method of claim 1, further comprising:
receiving a description of an output format, wherein the output format description describes a format of an output of the Parser by specifying a result object, and wherein the result object specification includes a set of one or more pairs of a name and a value; and
creating the result object;
wherein a parser object sets a value of an attribute of the result object based on a string.

5. The method of claim 4, wherein the target file describes a configuration of a device, and wherein the result object is an extensible data structure that includes custom-defined fields whose values reflect the device configuration.

6. The method of claim 4, wherein the target file was output by a device in response to a command that was received by the device, and wherein the result object is used to generate a command to send to the device.

7. A computer program product for generating a Parser to parse a target file, wherein the computer program product is stored on a computer-readable medium that includes instructions that, when loaded into memory, cause a processor to perform a method, the method comprising:
receiving a description of the target file, wherein the target file description describes a grammar of the target file by specifying a set of one or more parsers, and wherein each parser specification includes one or more pairs of a name and a value;
creating a data structure that represents the target file description; and
creating, for each parser in the set of parsers, an object that can parse a string.

8. A system for generating a Parser to parse a target file, the system comprising:
a computer-readable medium that includes instructions that, when loaded into memory, cause a processor to perform a method, the method comprising:
receiving a description of the target file, wherein the target file description describes a grammar of the target file by specifying a set of one or more parsers, and wherein each parser specification includes one or more pairs of a name and a value;
creating a data structure that represents the target file description; and
creating, for each parser in the set of parsers, an object that can parse a string; and
a processor for performing the method.
